(19) United States
(12) Patent Application Publication
(10) Pub. No.: US 2023/0394583 A1
(43) Pub. Date: Dec. 7, 2023

(54) CUSTOMER PARTNER PROGRAM METHODS AND SYSTEMS

(71) Applicants: Brian Richard Fast, Kirtland, OH (US); Timothy Lloyd Bratz, Isle of Palms, SC (US)

(72) Inventors: Brian Richard Fast, Kirtland, OH (US); Timothy Lloyd Bratz, Isle of Palms, SC (US)

(21) Appl. No.: 18/329,559

(22) Filed: Jun. 5, 2023

Related U.S. Application Data
(60) Provisional application No. 63/349,040, filed on Jun. 3, 2022.

(51) Int. Cl. G06Q 40/06

(52) U.S. Cl. CPC G06Q 40/06

(57) ABSTRACT

Computer-implemented customer partner program methods, systems, and computer-readable media are described.

### RELATED APPLICATIONS

This application claims the benefit of U.S. Provisional Application No. 63/349,040, entitled “Customer partner program Methods and Systems,” and filed on Jun. 3, 2023, which is incorporated herein by reference in its entirety.

### FIELD

Some implementations are generally relate to computer networks, and, more particularly, to methods and systems for a customer partner program network.

### BACKGROUND

Technology businesses, if they are successful, typically experience a rate of growth that may exceed the growth rate of established businesses in traditional sectors or industries. The rapid growth of technology companies may be due in part to the ability of technology companies to acquire new customers or users very rapidly and often with little or no cost once word of a new technology begins to spread. Retaining users may contribute to the growth and/or value of a technology company. The profitability of technology companies, especially software companies, is at least partially a result of the low cost to provide the software to customers once the software is developed. For example, in a Software as a Service (SaaS) entity, the software is delivered as a service across a network such as the Internet. Thus, lowering the cost of software delivery compared to the delivery costs of physical products.

Software as a Service (SaaS) companies may seek to attract new customers or users and grow the number of items/users/usage/information (e.g., user accounts, assets under management, frequency of use, content, etc.) managed or serviced by the SaaS system to demonstrate that the SaaS product has a viable business case behind it. With conventional SaaS systems, customers simply pay for a license (if the SaaS system charges a fee) according to some payment model such as single payment, subscription payment, or grant right to generate revenue based on data/usage/information, etc. In the bargain, customers get a license or access to use the SaaS system in exchange for paying the license fee or granted rights to the SaaS. There is typically no other connection between the customers and the entity the provides the SaaS system.

There may be a need for customers of a SaaS system and the entity operating the SaaS system to form a partnership so that the SaaS entity can encourage user base growth and the SaaS entity can offer ownership in the entity as a reward for adoption of the SaaS system and continued use of the SaaS system.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method comprising determining a first percentage (or number) of shares of a SaaS business entity to allocate to a customer partner program and receiving an indication of one or more new items or users or information of a SaaS system. The method can also include determining whether ownership units (e.g., electronic tokens corresponding to a number of shares or percentage ownership in an entity or asset, where the number and percentage can be fractional) in the SaaS business entity are available, and when ownership units are available, allocating one or more unvested ownership units to one or more customers (or customers of customers, and so on recursively down a hierarchy of customers, etc.) or partners of the SaaS business entity based one or more of number of items (e.g., number and/or type of items and/or information managed by SaaS system), users (e.g., type of user and number of users), usage (e.g., frequency of use), information (e.g., desired content), priority, longevity, and/or user type. Partner can also include content and information providers that produce content that other standard customers would consume or utilize. Further, in some implementations, the ownership units could be split between two or more entities (e.g., partners or customers) associated with a given user of the SaaS system (e.g., customers, customers of customers, etc. as mentioned above). For example, the two entities could be an apartment complex owner and the management company for the complex. In another example, the two entities could be a service customer and a distributor. Further, in some implementations, a given function for allocating ownership units could be adjustable on a per user basis to provide certain incentives for specific users.

The method can also include converting the unvested ownership units in the SaaS business entity into a vested ownership units (e.g., whole or fractional units) in the SaaS business entity when a combination of criteria are met, wherein the combination of criteria include maintaining a subscription or use agreement to the SaaS system for one of: a first predetermined time period elapsing without shares in the SaaS business entity becoming publicly traded, or a second predetermined time period elapsing after shares in the SaaS business entity become publicly traded, or some limit associated with a usage definition for allocating an ownership unit, such as items sold, revenue volumes, clicks, likes, comments, items produced, events, triggers, or the like. A subscription can include user usage and/or user and/or content creators providing data, info, content, media, AI training data, notifications, or the like. While vesting is described herein in terms of a time factor, it should be appreciated that this is for illustration purposes. Other vesting measures or criteria could be used. For example, there could be a situation where vesting is based upon value creation. For example, vesting may be dependent on a number of views exceeding a threshold value x. The subscription can be according to one or more parameters, such as an uninterrupted, fully paid subscription, or a subscription according to other terms. For example, the subscription could be free, and could be paused or stopped. In some implementations, for subscription statuses other than continuous, fully paid, the ownership percentages or vesting schedules can be adjusted or terminated. The subscription parameters can include continual use (which may be paused or terminated at the SaaS or customer discretion) or agreeing to the use agreement (which may include fully paid subscription or other agreement per SaaS customer program).

In some implementations, a customer partner program can be focused on an individual product or service provided by a unit, division, or subsidiary of a parent entity, where the ownership units are provided for the unit, division, or subsidiary of the parent entity corresponding to the individual product or service. In some implementations, a second customer partner program (e.g., a second “round” like a series B, C, D offering or the like) can be created to target customers and/or usage that did not participate and/or utilize a first customer partner program and to accommodate those new customers and/or usages.

In some implementations, determining the percentage share per subdivision of the asset managed by the software as a service system includes determining the percentage share per unit in a real estate property asset (e.g., a single-family house, a duplex or other multi-family house, an apartment building, a mobile home, a mobile home park, a commercial building, land, or the like).

Some implementations can include a computer-implemented method comprising receiving an indication of one or more new items or users of a SaaS system and issuing one or more electronic tokens to one or more customers of the SaaS system based on number of items/users/usage/information, timing, priority, and longevity. The method can also include determining if customer partner program is closed. The method can further include, when the customer partner program is closed, determining an ownership percentage or percentage of shares in a SaaS business entity, and allocating one or more unvested ownership units to one or more customers of the SaaS business entity based one or more of number of electronic tokens. It will be appreciated that the allocating a percentage of the SaaS business entity or shares can be performed prior to commencing the customer partner program or after the program has been closed. Further, it will be appreciated that an allocation of the SaaS business entity to the program can include a percentage of the SaaS business entity could be allocated to the program or a given number of shares could be allocated.

The method can also include converting the unvested ownership units in the SaaS business entity into a vested ownership units in the SaaS business entity when a combination of criteria are met, wherein the combination of criteria include maintaining a subscription and/or agreed upon use agreement to the SaaS system for one of: a first predetermined time period elapsing without shares in the SaaS business entity becoming publicly traded, or a second predetermined time period elapsing after shares in the SaaS business entity become publicly traded, or specific correlated thresholds are reached associated with value generation (e.g., thresholds for each customer partner associated with value generated). In some implementations, determining the percentage share per subdivision of the asset managed by the software as a service system includes determining the percentage share per unit in a real estate property asset. The subscription can be according to one or more parameters, such as an uninterrupted, fully paid subscription, or a subscription according to other terms. For example, the subscription could be free, and could be paused or stopped. In some implementations, for subscription statuses other than continuous, fully paid, the ownership percentages or vesting schedules can be adjusted or terminated. The subscription parameters can include continual use (which may be paused or terminated at the SaaS or customer discretion) or agreeing to the use agreement (which may include fully paid subscription or other agreement per SaaS customer program).

In addition to, or as an alternative to, the methods described above, some implementations can include a system comprising one or more processors coupled to a computer-readable medium having stored thereon software instructions that, when executed by the one or more processors, cause the one or more processors to perform operations including one or more of the steps described above.

Some implementations can include a computer-readable medium having stored thereon software instructions that, when executed by one or more processors, cause the one or more processors to perform operations including the operations described above.

### BRIEF DESCRIPTION OF THE DRAWINGS

FIG. 1 is a block diagram of an example system and a network environment which may be used for one or more implementations described herein.

FIG. 2 is a flowchart of an example fixed SaaS customer partner program method in accordance with some implementations.

FIG. 3 is a flowchart of an example open SaaS customer partner program method in accordance with some implementations.

FIG. 4 is a block diagram of an example computing device which may be used for one or more implementations described herein.

### DETAILED DESCRIPTION

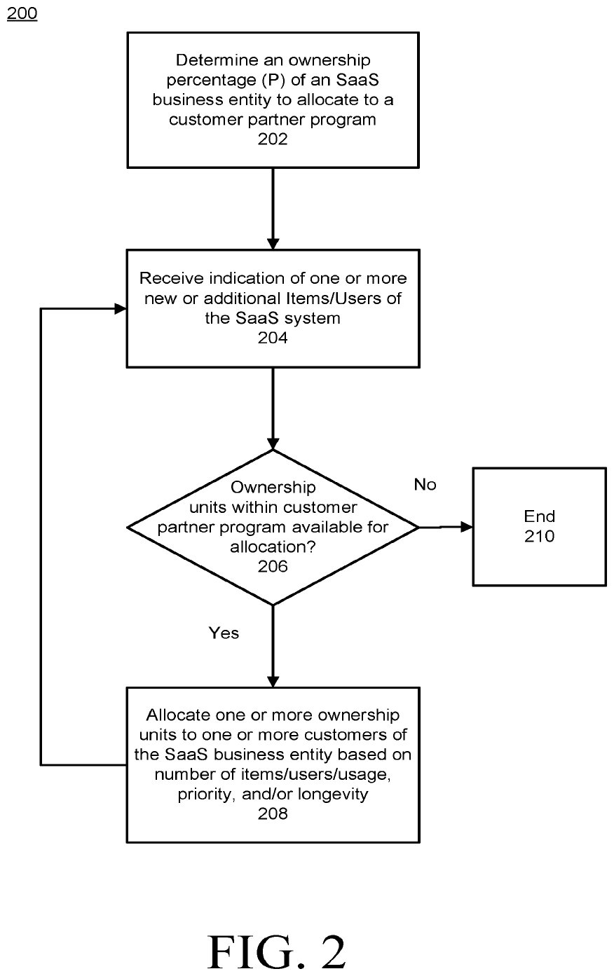

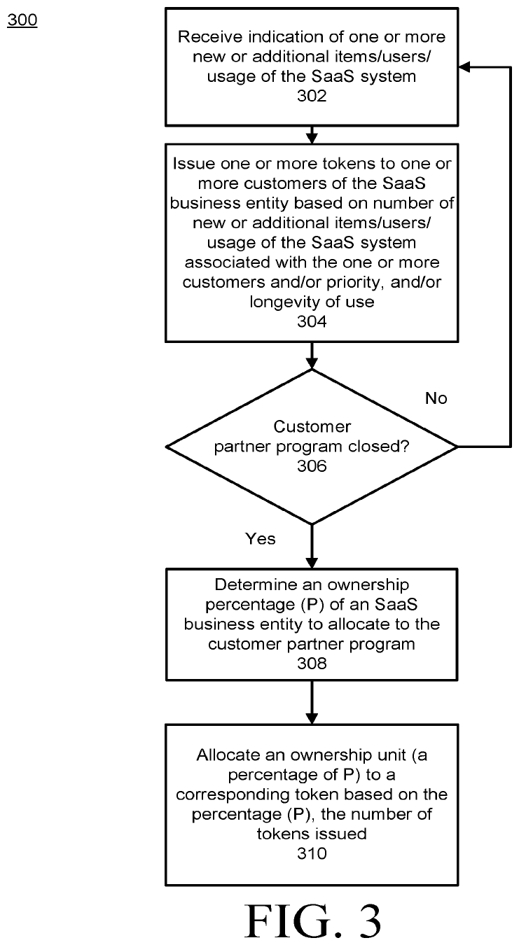

Some implementations include SaaS customer partner methods and systems. In general, some implementations can permit customers of a SaaS system to become ownership partners (e.g., owning one or more whole or fractional units of interest in an entity associated with the software) based on one or more factors such as the customer's level of usage of the SaaS system (e.g., number of users, number of items being managed by the SaaS system, providing information, utilizing the software, etc.), when the customer joined the SaaS system, how long the customer stays with the SaaS system, and the like. There can be at least two types of customer partner programs: fixed and open. The fixed program type is shown in FIG. 2 and described below. The open program type is shown in FIG. 3 and discussed below. The SaaS system can provide a service, perform a task, or the like and can be related to a physical asset (e.g., real estate, vehicles, collectibles, etc.) or an intangible asset such as data, audio, media, image, and/or video, information, securities, a game, a simulation, or the like. Ownership units can be issued for a parent entity or a subsidiary of a parent entity. For example, in some implementations, a customer partner program can be focused on an individual product or service provided by a unit, division, or subsidiary of a parent entity, where the ownership units can be provided for the parent entity or for the unit, division, or subsidiary of the parent entity corresponding to the individual product or service. In some implementations, a second customer partner program can be created to target customers and/or usage and/or new service(s) that did not participate in and/or utilize a first customer partner program and to accommodate those new customers and/or new customer uses in a customer partner program. While a SaaS system and associated business is described herein as a non-limiting example, it will be appreciated that the customer partner program can be configured for any type of business and associated product or service including physical products, physical services, digital products, digital services, operational services, predictive and/or prescriptive services, or a combination of two or more of the above and associated businesses or business divisions or subsidiaries. It should be noted that a traditional partnership is not necessary for the customer partner program described herein. However, in some cases there may be a traditional partnership and customer partners. For example, a software developer may create a traditional partnership (e.g., with a Commercial Real Estate company) to make sure the solution provides value to the customers. A customer partner program can be instituted after launch of the software to reward some customers to make sure cash flow is sustainable.

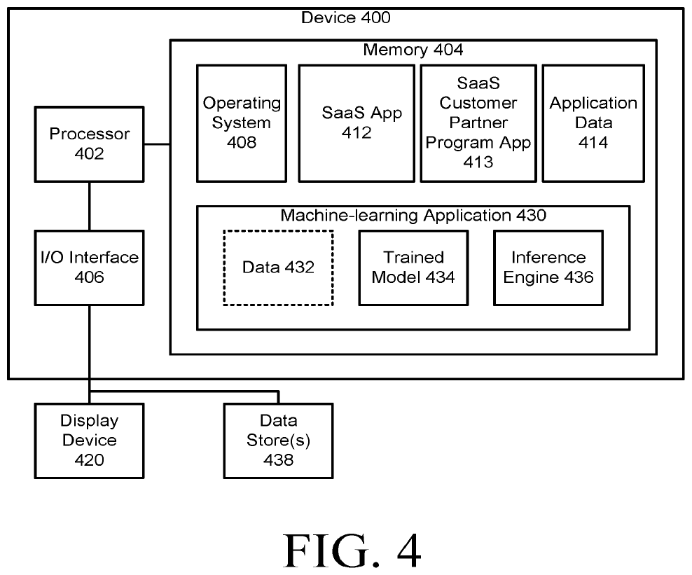

When performing SaaS customer partner functions, it may be helpful for a system to suggest one or more parameters of a SaaS customer partner program and/or to make predictions about profitability of a SaaS customer partner program. To make predictions or suggestions, a probabilistic model (or other model as described below in conjunction with FIG. 4) can be used to make an inference (or prediction) about aspects of a SaaS customer partner program such as profitability and/or evaluation and/or user/usage/information growth rate. Accordingly, it may be helpful to make an inference regarding a probability that a SaaS customer partner program will help attract new customers or users, may help retain users, or the like. Other aspects can be predicted or suggested as described below.

The inference based on the probabilistic model can include predicting SaaS system user base growth rate and/or SaaS system entity profitability in accordance with SaaS customer partner program parameters (or other data) analysis and confidence score as inferred from the probabilistic model. The probabilistic model can be trained with data including previous SaaS customer partner program data, SaaS system data, and/or SaaS system business entity data. The model can be updated using live data. Some implementations can include generating SaaS system predictions based on SaaS customer partner program parameters.

The systems and methods provided herein may overcome one or more deficiencies of some conventional SaaS systems and methods. For example, some conventional SaaS systems may not have an ownership connection between the SaaS customers or users and the entity that operates the SaaS system.

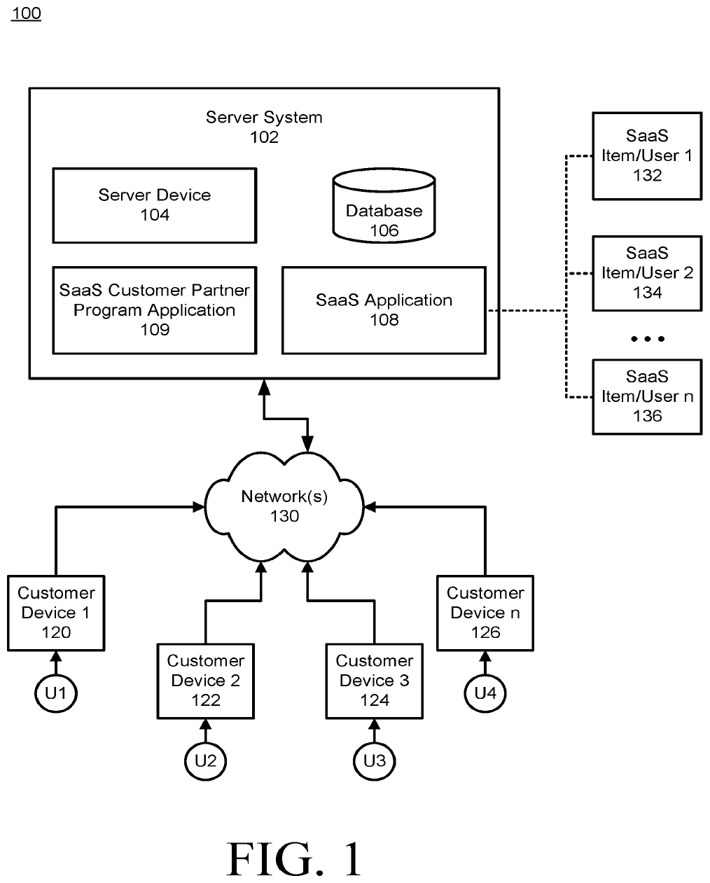

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, a SaaS application 108, and a SaaS customer partner program application 109. The SaaS application can manage or be associated with one or more items or users (132-136). For example, the SaaS application can be configured to manage assets (e.g., real estate assets, investments, etc.). The items/users/usage can include user accounts or any physical or virtual items or services or similar that may benefit from a SaaS application or system and/or usage patterns such as frequency of use. Network environment 100 also can include one or more client devices, e.g., customer devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for customer devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD, sensors), wristwatch, headset, armband, jewelry, etc.), virtual reality (VR) and/or augmented reality (AR) enabled devices, personal digital assistant (PDA), media player, game device, embedded system, medical equipment, programmable logic controllers (PLCs), connected sensors, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective customer devices 120, 122, 124, and 126. In some examples, users U1, U2, U3, and U4 may interact with each other via applications running on respective client devices and/or server system 102, and/or via a network service, e.g., a gaming service, a metaverse service, an image sharing service, a messaging service, a social network service or other type of network service, implemented on server system 102. For example, respective customer devices 120, 122, 124, and 126 may communicate data to and from one or more server systems (e.g., server system 102). In some implementations, the server system 102 may provide appropriate data to the client devices such that each client device can receive communicated content or shared content or executed transactions or explicit actions uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages or content or actions to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, content, transactions, and other data on customer devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, content, actions, transactions, etc. at the client device.

In some implementations, server system 102 and/or one or more customer devices 120-126 can provide SaaS customer partner program functions.

Various implementations of features described herein can use any type of system and/or service. For example, while a SaaS system is described herein an example, the disclosed subject matter is not limited to a SaaS system. Implementations can be configured for local installs, cloud deployments, mobile deployments, or hybrid deployments comprising two or more of the above. Any type of electronic device can make use of features described herein. Some implementations can provide one or more features described herein on customer (client) or server devices disconnected from or intermittently connected to computer networks.

### Example 1—Fixed Customer Partner Program

FIG. 2 is a flowchart of an example fixed SaaS customer partner program method 200 in accordance with some implementations. Processing begins at 202, where an ownership percentage (P) of a SaaS business entity to allocate to a customer partner program is determined. For example, the operator of the SaaS application or system may decide to allocate 20% of the company shares or ownership percentages to the SaaS customer partner program.

In some implementations, P percent of the SaaS software company (where P is defined by the company) can be set aside for the customer partner program. The customer partner program rewards customers that utilize the software (e.g., utilize the SaaS as a paid or free service) based on amount of use (how many items and/or information and/or users utilize the software). The P percent of the company is divided among the customer partners based on the number of items/users/usage/information (e.g., increased use) and when use begun for each item/user/information (e.g., to reward and incentivize early adoption and increased use). Utilization of the software can include a subscription. The subscription can be according to one or more parameters, such as an uninterrupted, fully paid subscription, or a subscription according to other terms. For example, the subscription could be free, and could be paused or stopped. In some implementations, for subscription statuses other than continuous, fully paid, the ownership percentages or vesting schedules can be adjusted or terminated. The subscription parameters can include continual use (which may be paused or terminated at the SaaS or customer discretion) or agreeing to the use agreement (which may include fully paid subscription or other agreement per SaaS customer program). Processing continues to 204.

At 204, an indication is received that a customer is adding one or more new items or users or usage or information to the customer's account in the SaaS system. For example, if the SaaS system is one to manage commercial property, the indication may be that the customer of the SaaS application is adding one or more assets (e.g., a single-family house, a duplex or other multi-family house, an apartment building, a mobile home, a mobile home park, a commercial building, land, or the like) to be monitored with help from the SaaS application. In another example, the customer could be adding users to the customer's account and/or information and/or usage in the SaaS system. Processing continues to 206.

At 206, the system determines if any ownership units within the customer partner program are available for allocation. For example, this determination can be based on a calculation using the percentage P, quantity of items/users/usage/information added to the customer partner program by members, and any weighting for the items/users/usage/information based on when they are being added to the program. If there are ownership units to allocate, processing continues to 208. Otherwise, processing continues to 210, where processing ends.

At 208, one or more ownership units are allocated to one or more customers of the SaaS business entity based on one or more of number of items/users/usage/information, priority, and/or longevity. For example, in a fixed program, which sets aside a max number of items/users/usage/information that could be admitted into the program. For example, the program may accept the first 1 M units (e.g., keys or units within a multi-unit property).

In a simple example, the max number of items/users/usage/information could be split into 4 different ranges, i.e., 0-250 k, 250 k-500 k, 500 k-750 k, 750 k-1 M. In this scenario, early adoption would be rewarded by weighting each item/user differently; for example, each item/user could be weighted by 1.0, 0.75, 0.5, 0.25 based on when the item/user/information started using the SaaS, i.e., which range its within when entering the program. With these weightings, a non-obvious calculation is used to calculate the ratio of the P percentage per item/user/information based on when the item entered the program. This also permits the system to calculate how much of the percentage is allocated to each range to choose the appropriate weightings to achieve the business objectives (e.g., early adoption vs. long term adoption). For this example, illustrated below in Table 1, each range contains 40%, 30%, 20%, and 10%.

An example general process for calculating the ratio of the P percentage per item/user/information will track the ownership unit percentage per item/user based on when the item entered the program. The ownership unit is equal to the weighting based on the range when the item/user/information entered the program. By summing the total ownership units, the ratio of the actual ownership unit divided by total ownership units can be used to determine the actual ratio of the P percentage per ownership unit or item/user based on when it entered the program.

A same or similar process can be used for a complex (e.g., exponential) weighting function. With more complex weighting functions different ranges may not be necessary. However, the same ownership unit concept would be utilized to calculate the ratio of the P percentage per item/user based on when it entered the program. The specific exponential decay rate could be chosen based on desire to commercially reward early adoption and usage (reach critical threshold and usage) vs. long term adoption (larger user base and usage).

Some implementations can be relatively simple to explain to customers. Choosing the maximum number can be complicated, prior to having any revenue or profit margins, and completely impacts whether the program is focused on securing a critical adoption level (some minimum threshold for sustainability) vs. long term growth (larger user base).

Some implementations may choose to determine ownership percentage or shares of a SaaS business entity to allocate to a customer partner program 202 once all ownership units have been assigned, e.g., at output of 206.

### Example 2—Open Customer Partner Program

FIG. 3 is a flowchart of an example open SaaS customer partner program method 300 in accordance with some implementations. Processing begins at 302, where an indication is received that a customer is adding one or more new items or users to the customer's account in the SaaS system. For example, if the SaaS system is one to manage commercial property, the indication may be that the customer of the SaaS application is adding one or more assets (e.g., a house, apartment building, or the like) to be monitored with help from the SaaS application. In another example, the customer could be adding users to the customer's account in the SaaS system. The customers use can be according to a subscription and/or usage and/or data and/or information, etc. The subscription can be according to one or more parameters, such as an uninterrupted, fully paid subscription, or a subscription according to other terms. For example, the subscription could be free, and could be paused or stopped. In some implementations, for subscription statuses other than continuous, fully paid, the ownership percentages or vesting schedules can be adjusted or terminated. The subscription parameters can include continual use (which may be paused or terminated at the SaaS or customer discretion) or agreeing to the use agreement (which may include fully paid subscription or other agreement per SaaS customer program). Processing continues to 304.

At 304, one or more electronic tokens are assigned to one or more customers of the SaaS system business entity based on the number of new or additional items/users/usage/information of the SaaS system associated with the one or more customers. An open program, such as that shown in FIG. 3, will keep accepting items/users/usage/information until the SaaS application entity decides to close the program. The closed program process explained above regarding FIG. 2 applies with two primary differences:

The ratio of the P percentage assigned to each thing is not assigned until the program is closed. While the program is open, the customer is only assigned a electronic token as a placeholder ownership unit. The electronic token has value, similar to a cryptocurrency, and can be converted to company ownership once the program is closed. The conversion isn't made until the end because the total electronic tokens assigned aren't known, i.e., denominator is unknown until closed.

Due to this structure, the weighting function does not need to be preassigned either. The company can choose how to change the weighting as an item/user/information enters the program to maximize the business objectives. An open program can provide greater flexibility to achieve business objectives based on actual performance, which in the end can actually provide more value to the customer partner. Processing continues to 306.

At 306, it is determined whether the customer partner program has closed. If the program has closed, processing continues to 308. Otherwise, processing continues back to 302.

At 308, an ownership percentage (P) allocated to the customer partner program is determined. In some implementations, step 308 could be a first step or a later step in other implementations. Processing continues to 310.

At 310, a percentage ownership (e.g., a percentage of P of an asset or subdivision of an asset or number of shares of an entity, where the percentage or number can be fractional) is allocated to a corresponding electronic token based on the percentage (P) and the number of electronic tokens issued. For example, allocating a percentage ownership per electronic token can include determining a percentage share per subdivision of the asset managed by the software as a service system such as determining the percentage share per unit in a real estate property asset (e.g., a single-family house, a duplex or other multi-family house, an apartment building, a mobile home, a mobile home park, a commercial building, land, or the like).

In some implementations, the method can include an ability to reward multiple customers for the same item/user/information. For example, each asset may actually have multiple customers (relative to us) that should be rewarded. In an apartment complex example, this may include the owner and property manager. In a factory, this may include the end user and an OEM integrator. In each example, different weighting functions are assigned, and total units are tracked to appropriately assign the appropriate ratio of P percentage per item/user per customer.

In some implementations, customer partner program includes vesting terms that the SaaS is used with specified constraints for a period of time and/or rate of usage and/or value generated. For example, this can include a specific time range and constraints on not being able to sell until a certain period after the IPO. In some implementations, the vesting method can also include converting the unvested ownership units in the SaaS business entity into a vested ownership units in the SaaS business entity when a combination of criteria are met, wherein the combination of criteria include maintaining a subscription and/or agreed upon use agreement to the SaaS system for one of: a first predetermined time period elapsing without shares in the SaaS business entity becoming publicly traded, or a second predetermined time period elapsing after shares in the SaaS business entity become publicly traded, or specific correlated thresholds are reached associated with value generation. In some implementations, determining the percentage share per subdivision of the asset managed by the software as a service system includes determining the percentage share per unit in a real estate property asset.

In some implementations, the customer partner program can include a constant weighting, meaning a ratio of P percent ownership is only dependent on item/user integrated into the SaaS. However, the early adoption is rewarded by reducing the vesting constraints, i.e., conversion time.

In some implementations early adoption can be rewarded by reducing the vesting constraints, i.e., conversion time.

In some implementations, the customer partner program can include different weightings based on the level of services each item/user utilizes.

Example Applications

As used herein, partners can include customers. In some cases, there can be a hierarchy where first tier customers have second tier customers, and second tier customers have third tier customers and so on.

Software Customer Examples

Real Estate Software Example
Property Owners
Property Owners+Tenants
Property Owners+Property Managers
Property Owners+Property Managers+Tenants

Some implementations can include a software product for managing assets such as real estate. The software company may look to incentivize some users and/or customers associated with the asset, that may directly or indirectly associate with the software, such as: property owners, property owners and property managers, property owners, property managers, and tenants.

Insurance Software Example
Insurance Company
Insurance Company+Insurers
Insurance Company+Agents
Insurance Company+Agents+Insurers

Some implementations can include a software product for managing insurance products. The software company may look to incentivize some users and/or customers associated with the insurance, that may directly or indirectly associate with the software, such as: insurance company, insurance company & insurers, insurance company & agents, insurance company & agenda & insurers.

Machines (can Include a Similar Model for Other Industries)
Control provider (e.g., Rockwell)
Control provider+end user (e.g., P&G)
Control provider+end user (e.g., P&G)+OEM (e.g., Cloostermans)

Some implementations can include a software product for managing assets such as machines. The software company may look to incentivize some users and/or customer associated with machines, that may directly or indirectly associate with the software, such as: established control provider, established control provider & end user, established control provider & end user & OEM.

Online Car Sale Software Example

Local Dealers—An app for a contractor looking for a car. The app can search car dealerships based on need by date to find the closest vehicles and cheapest prices. Local dealers would be considered a customer partner and be rewarded based on scaling algorithm for items bought based on scaling algorithm. This would motivate customer partners to provide services most aligned with our business outcomes.

Some implementations can include a software product for selling cars from local dealerships. The software company may look to incentivize some local dealerships associated with car sales.

Online Hardware Store Software Example

Local Hardware Stores—Some implementations can include an app for a contractor looking for items form a part list. The app can be configured to search stores based on need by date to find the closest and cheapest prices. The hardware store would be considered a customer partner and rewarded based on items bought according to a scaling algorithm. Such a configuration would motivate the store to provide services most aligned with business outcomes.

Some implementations can include a software product for selling products from local stores. The software company may look to incentivize some local stores and/or manufactures associated with local stores.

Online Education Software Example
Large schools
This would be much like the real estate example
This could have a version associated with content creators that rewards based on use.
Colleges

This would be similar to the real estate example. Some implementations can include a version associated with content creators that rewards based on use.

Some implementations can include a software product for educational products. The software company may look to incentivize some content creators and/or education providers (schools or universities).

Large Organization Software Example for Operational Planning and Coordination
Sports organizations
Large churches
Hospitals

This would be similar to the real estate example.

Some implementations can include a version associated with content creators that rewards based on use.

Some implementations can include a software product for running operations for specific industries (sports, churches, hospitals, etc.). The software company may look to incentivize some large organizations that utilize the platform.

Online Task Tracking

Large corporations—This would be much like the real estate example

Some implementations can include a software product for task tracking and project management. The software company may look to incentivize some large organizations that utilize the platform.

Some implementations can be configured for social media, media, music platforms, artists, influencers, contributors or any combination of the above.

In some implementations, a social media example, can be configured to create a media streaming service and treat an artist (e.g., Taylor Swift) as a customer partner. As a customer partner, Taylor would not be paying for the service. She would be publishing content to the platform. Her metrics would be views, views/time period, and length of time. She would be rewarded based on her contents ratio metric impact based on scaling algorithm. This would yield itself to the open program where total value generated would be accessed upon program close.

An influencer, considered a customer partner, pushing to a platform through their platform and a provided hyperlink that's trackable. Through pushes and conversations, this influencer would be rewarded based on ratio metric impact based on scaling algorithm. This would yield itself to the open program where total value generated would be accessed upon program close.

Some implementations can include a software product for social media or music platforms. The software company may look to incentivize content producers and influencers.

Some implementations can be configured for customers that train AI models: For example, a company that utilizes general AI and has customer partners that utilize the platform but also extend its functionality in an open way. These Customer Partners provide additionally trained AI models to expand the functionality. As that customer's AI model is utilized by others, then the customer would be rewarded based on ratio metric impact based on scaling algorithm.

Some implementations can include a software product for leveraging existing AI models to do something. The software company may look to incentivize some large organizations that provide resources, credibility, data and utilize the service. This could include multiple types of customer partners such as Microsoft providing processing resources and credibility and/or additional company's utilizing the product (data, training, utilizing solutions).

Companies that utilize their employees/data to train AI models. Customer partner would be these companies that provide employee data or leverage employees that are utilizing early versions for existing tasks and refine the process. These companies would be rewarded based on ratio metric impact (data provided and/or successful outcomes) based on scaling algorithm.

Some implementations can include a software product for developing new AI models to perform given predictions or classifications, etc. The software company may look to incentivize large organizations that provide resources, credibility, data and utilize the service. This could include multiple types of customer partners such as Nvidia providing processing resources and credibility and/or additional companies utilizing the product (data, training, utilizing solutions).

In some implementations, customer partners may receive money or give money or freely participate in addition to rewarded unvested shares or tokens.

In some implementations, customer partners program may include one or more types of customer partners. In this case, the scaling algorithm would determine who would be rewarded based on value created.

In some implementations, when defining core company, customer, customer's customer in AI and edge solutions, one can include different combinations within the description.

Core Company Example: Nvidia and/or MSFT
Customer: AI developers (could be multiple)
Customer's customer: Company's leveraging their data (likely multiple companies but in this structure customers customer could source data among multiple AI developers to increase odds of success)
Core company example: AI developer
Customer type 1: Nvidia and/or MSFT
Customer type 2: Company's leveraging their data (likely multiple companies)

Customers may include one or multiple customer types. Further, being based on outcome performance metrics permit multiple “efforts” to be tried in parallel and only the ones that provide value would be rewarded.

FIG. 4 is a block diagram of an example device 400 which may be used to implement one or more features described herein. In one example, device 400 may be used to implement a client device, e.g., any of customer devices 120-126 shown in FIG. 1. Alternatively, device 400 can implement a server device, e.g., server device 104, etc. In some implementations, device 400 may be used to implement a client device, a server device, or a combination of the above. Device 400 can be any suitable computer system, server, or other electronic or hardware device as described above.

One or more methods described herein (e.g., 200 and/or 300) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 400 includes a processor 402, a memory 404, and I/O interface 406. Processor 402 can be one or more processors and/or processing circuits to execute program code and control basic operations of the device 400. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 402 may include one or more co-processors that implement neural-network processing. In some implementations, processor 402 may be a processor that processes data to produce probabilistic output, e.g., the output produced by processor 402 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is typically provided in device 400 for access by the processor 402 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 402 and/or integrated therewith. Memory 404 can store software operating on the server device 400 by the processor 402, including an operating system 408, machine-learning application 430, SaaS application 412 and SaaS customer partner application 413, and application data 414. While a SaaS application 412 is described herein an example, the disclosed subject matter is not limited to a SaaS system. Implementations can be configured for local installs, cloud deployments, or hybrid deployments comprising two or more of the above. Other applications may include applications such as a data display engine, web hosting engine, image display engine, notification engine, social networking engine, etc. In some implementations, the machine-learning application 430, SaaS application 412, and SaaS customer partner program application 413 can each include instructions that enable processor 402 to perform functions described herein, e.g., some or all of the methods of FIGS. 2 and/or 3.

The machine-learning application 430 can include one or more NER implementations for which supervised and/or unsupervised learning can be used. The machine learning models can include multi-task learning based models, residual task bidirectional LSTM (long short-term memory) with conditional random fields, statistical NER, etc. The Device 400 can also include a SaaS application 412 and a SaaS customer partner program application 413 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 430 may utilize Bayesian classifiers, support vector machines, neural networks, or other learning techniques. In some implementations, machine-learning application 430 may include a trained model 434, an inference engine 436, and data 432. In some implementations, data 432 may include training data, e.g., data used to generate trained model 434. For example, training data may include any type of data suitable for training a model for SaaS customer partner program tasks, such as parameters, labels, thresholds, etc. associated with SaaS customer partner program tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 434, training data may include such user data. In implementations where users permit use of their respective user data, data 432 may include permitted data.

In some implementations, data 432 may include collected data such as SaaS customer partner program parameters, SaaS system data, etc. . . . . In some implementations, training data may include synthetic data generated for the purpose of training, such as data that is not based on user input or activity in the context that is being trained, e.g., data generated from simulated conversations, computer-generated images, etc. In some implementations, machine-learning application 430 excludes data 432. For example, in these implementations, the trained model 434 may be generated, e.g., on a different device, and be provided as part of machine-learning application 430. In various implementations, the trained model 434 may be provided as a data file that includes a model structure or form, and associated weights. Inference engine 436 may read the data file for trained model 434 and implement a neural network with node connectivity, layers, and weights based on the model structure or form specified in trained model 434.

Machine-learning application 430 also includes a trained model 434. In some implementations, the trained model 434 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 432 or application data 414. Such data can include, for example, images, e.g., when the trained model is used for SaaS customer partner program functions. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In different implementations, the trained model 434 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 434 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 432, to produce a result.

For example, training may include applying supervised learning techniques. In supervised learning, the training data can include a plurality of inputs (e.g., a set of images) and a corresponding expected output for each input (e.g., one or more labels for each image representing aspects of a project corresponding to the images such as services or products needed or recommended). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner. For example, the model may be trained to predict SaaS customer partner program parameters and/or select thresholds for parameters.

In another example, a model trained using unsupervised learning may cluster words based on the use of the words in data sources. In some implementations, unsupervised learning may be used to produce knowledge representations, e.g., that may be used by machine-learning application 430. In various implementations, a trained model includes a set of weights, or embeddings, corresponding to the model structure. In implementations where data 432 is omitted, machine-learning application 430 may include trained model 434 that is based on prior training, e.g., by a developer of the machine-learning application 430, by a third-party, etc. In some implementations, trained model 434 may include a set of weights that are fixed, e.g., downloaded from a server that provides the weights.

Machine-learning application 430 also includes an inference engine 436. Inference engine 436 is configured to apply the trained model 434 to data, such as application data 414, to provide an inference. In some implementations, inference engine 436 may include software code to be executed by processor 402. In some implementations, inference engine 436 may specify circuit configuration (e.g., for a programmable processor, for a field programmable gate array (FPGA), etc.) enabling processor 402 to apply the trained model. In some implementations, inference engine 436 may include software instructions, hardware instructions, or a combination. In some implementations, inference engine 436 may offer an application programming interface (API) that can be used by operating system 408 and/or SaaS application 412 to invoke inference engine 436, e.g., to apply trained model 434 to application data 414 to generate an inference.

Machine-learning application 430 may provide several technical advantages. For example, when trained model 434 is generated based on unsupervised learning, trained model 434 can be applied by inference engine 436 to produce knowledge representations (e.g., numeric representations) from input data, e.g., application data 414. For example, a model trained for SaaS customer partner program tasks may produce predictions and confidences for given input information about a SaaS customer partner program project being proposed or planned. A model trained for predicting SaaS customer partner program parameters may produce a suggestion for one or more parameters of a SaaS customer partner program. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 436.

In some implementations, knowledge representations generated by machine-learning application 430 may be provided to a different device that conducts further processing, e.g., over a network. In such implementations, providing the knowledge representations rather than the raw data may provide a technical benefit, e.g., enable faster data transmission with reduced cost.

In some implementations, machine-learning application 430 may be implemented in an offline manner. In these implementations, trained model 434 may be generated in a first stage and provided as part of machine-learning application 430. In some implementations, machine-learning application 430 may be implemented in an online manner. For example, in such implementations, an application that invokes machine-learning application 430 (e.g., operating system 408, one or more of SaaS application 412 and/or SaaS customer partner program application 413 or other applications) may utilize an inference produced by machine-learning application 430, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 434, e.g., to update embeddings for trained model 434.

In some implementations, machine-learning application 430 may be implemented in a manner that can adapt to particular configuration of device 400 on which the machine-learning application 430 is executed. For example, machine-learning application 430 may determine a computational graph that utilizes available computational resources, e.g., processor 402. For example, if machine-learning application 430 is implemented as a distributed application on multiple devices, machine-learning application 430 may determine computations to be carried out on individual devices in a manner that optimizes computation. In another example, machine-learning application 430 may determine that processor 402 includes a GPU with a particular number of GPU cores (e.g., 1000) and implement the inference engine accordingly (e.g., as 1000 individual processes or threads).

In some implementations, machine-learning application 430 may implement an ensemble of trained models. For example, trained model 434 may include a plurality of trained models that are each applicable to same input data. In these implementations, machine-learning application 430 may choose a particular trained model, e.g., based on available computational resources, success rate with prior inferences, etc. In some implementations, machine-learning application 430 may execute inference engine 436 such that a plurality of trained models is applied. In these implementations, machine-learning application 430 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 408 or one or more other applications, e.g., SaaS application 412 and/or SaaS customer partner program application 413.

In different implementations, machine-learning application 430 can produce different types of outputs. For example, machine-learning application 430 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 430 may produce an output video with a particular effect applied, e.g., rendered in a comic-book or particular artist's style, when trained model 434 is trained using training data from the comic book or particular artist, etc. In some implementations, machine-learning application 430 may produce an output based on a format specified by an invoking application, e.g., operating system 408 or one or more applications, e.g., SaaS application 412 or SaaS customer partner program application 413. In some implementations, an invoking application may be another machine-learning application. For example, such configurations may be used in generative adversarial networks, where an invoking machine-learning application is trained using output from machine-learning application 430 and vice-versa.

Any of software in memory 404 can alternatively be stored on any other suitable storage location or computer-readable medium. In addition, memory 404 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the server device 400 with other systems and devices. Interfaced devices can be included as part of the device 400 or can be separate and communicate with the device 400. For example, network communication devices, storage devices (e.g., memory and/or database 106), and input/output devices can communicate via I/O interface 406. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 406 can include one or more display devices 420 and one or more data stores 438 (as discussed above). The display devices 420 that can be used to display content, e.g., a user interface of an output application as described herein. Display device 420 can be connected to device 400 via local connections (e.g., display bus) and/or via networked connections and can be any suitable display device. Display device 420 can include any suitable display device such as an LCD, LED, or plasma display screen, CRT, television, monitor, touchscreen, 3-D display screen, or other visual display device. For example, display device 420 can be a flat display screen provided on a mobile device, multiple display screens provided in a goggles or headset device, or a monitor screen for a computer device.

The I/O interface 406 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 4 shows one block for each of processor 402, memory 404, I/O interface 406, and software blocks 408, 412, 413, and 430. These blocks may represent one or more processors or processing circuitries, operating systems, memories, I/O interfaces, applications, and/or software modules. In other implementations, device 400 may not have all of the components shown and/or may have other elements including other types of elements instead of, or in addition to, those shown herein. While some components are described as performing blocks and operations as described in some implementations herein, any suitable component or combination of components of environment 100, device 400, similar systems, or any suitable processor or processors associated with such a system, may perform the blocks and operations described.

In some implementations, the SaaS customer partner program system could include a machine-learning model (as described herein) for tuning the system (e.g., selecting SaaS customer partner program parameters and corresponding thresholds) to potentially provide improved accuracy. Example machine-learning model input can include labels for a simple implementation and can be augmented with descriptor vector features for a more advanced implementation. Output of the machine-learning module can include a prediction of SaaS customer partner program parameters, SaaS system growth or profitability.

One or more methods described herein (e.g., method 200 and/or 300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A system comprising:
one or more processors coupled to a computer-readable medium having stored thereon software instructions that, when executed by the one or more processors, cause the one or more processors to perform operations including:
determining a first percentage of shares of a Software as a Service (SaaS) business entity to allocate to a customer partner program;
receiving an indication of one or more new items, users, information or usage of an SaaS system;
determining whether ownership units in the SaaS business entity are available; and
when ownership units are available, allocating one or more or fractional unvested ownership units to one or more customers of the SaaS business entity based on one or more of number of items/users/usage/information, priority, and longevity.

2. The system of claim 1, wherein the operations further comprise:
converting the unvested ownership units in the SaaS business entity into vested ownership units in the SaaS business entity when a combination of criteria are met, wherein the combination of criteria includes maintaining usage or subscription to the SaaS system, within one or more predetermined parameters, for one of: a first predetermined time period elapsing without shares in the SaaS business entity becoming publicly traded, or a second predetermined time period elapsing after shares in the SaaS business entity become publicly traded, specific correlated thresholds are reached associated with value generation.
